(19) United States
(12) Patent Application Publication
(10) Pub. No.: US 2009/0072762 A1
(43) Pub. Date: Mar. 19, 2009

(54) Backlight control circuit and method for driving same

(75) Inventor: Sha Feng, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO.,LTD.;; INNOLUX DISPLAY CORP.

(21) Appl. No.: 12/283,823

(22) Filed: Sep. 15, 2008

(30) Foreign Application Priority Data
Sep. 14, 2007 (CN) 200710077000.1

(51) Int. Cl. H05B 37/02

(52) U.S. Cl. 315/307

(57) ABSTRACT

An exemplary backlight control circuit includes a transformer, a control circuit, a lamp. The control circuit and the transformer form an inverter circuit to providing an alternating current (AC) voltage for driving the lamp. When the backlight control circuit works in a startup mode, the backlight control circuit defines a first current path including the lamp and the first current path forms a first resonant circuit. When the backlight control circuit works in an operation mode, the backlight control circuit defines a second current path including the lamp and the second current path forms a second resonant circuit. The first and second resonant circuits have different resonant frequencies from each other.

### FIELD OF THE INVENTION

The present disclosure relates to a backlight control circuit which can for example be employed in a liquid crystal display (LCD), and more particularly to a backlight control circuit defining two different resonant circuits and a method for driving the backlight control circuit.

### GENERAL BACKGROUND

LCDs have been widely used in various portable information products such as notebooks, personal digital assistants (PDAs), and video cameras, due to advantages such as portability, low power consumption, and low radiation. LCDs are poised to completely replace cathode ray tube monitors and televisions in some markets. A typical LCD includes an LCD panel, a backlight for illuminating the LCD panel, and a backlight control circuit for controlling the backlight. When a cold cathode fluorescent lamp (CCFL) is employed as the backlight, a high frequency alternating current (AC) voltage is generated by the backlight control circuit for driving the CCFL.

Referring to FIG. 4, one such backlight control circuit 100 includes a control circuit 110, a transformer 120, a lamp 130, and a capacitor 140.

The transformer 120 includes a primary winding 122 and a secondary winding 124. Two terminals of the primary winding 122 are electrically coupled to the control circuit 110. One terminal of the secondary winding 124 is grounded via the lamp 130, and the other terminal of the secondary winding 124 is grounded via the capacitor 140. The lamp 130 is a CCFL.

The control circuit 110 and the transformer 120 constitute an inverter circuit configured for providing an AC voltage to driving the lamp 130. Normally, because the AC voltage outputted from the secondary winding 124 is not a sine wave, the capacitor 140 and the secondary winding 124 need to form an resistor inductor capacitor (RLC) resonant circuit in order to provide an AC voltage with a desired sine wave for driving the lamp 130.

The RLC resonant circuit includes a fixed resonant frequency f₀. When the resonant frequency f₀ is equal to or close to a driving frequency of the AC voltage, an efficiency of the backlight control circuit 100 is high and energy waste is low. Thus an important quality factor of the backlight control circuit 100 is high.

The AC voltage includes a normal operation frequency f₁, and a startup frequency f₂ for lighting up the lamp 130 when the backlight control circuit 100 starts to work. Because the startup frequency f₂ is higher than the normal operation frequency f₁, the fixed resonant frequency f₀ of the RLC resonant circuit can only correspond to one of the normal operation frequency f₁ and the startup frequency f₂. If the fixed resonant frequency f₀ corresponds to the startup frequency f₁, the fixed resonant frequency f₀ is higher than the normal operation frequency f₂. Thus the efficiency of the backlight control circuit 100 is low and energy waste is high. If the fixed resonant frequency f₀ corresponds to the normal operation frequency f₁, the fixed resonant frequency f₀ is lower than the startup frequency f₁, Thus each time the lamp 130 is lighted up, flicker is generated in the lamp 130, and the working lifetime of the lamp 130 is reduced by a decrement.

It is desired to provide a new backlight control circuit which can overcome the above-described deficiencies

### SUMMARY

A backlight control circuit includes a transformer, a control circuit, a lamp. The control circuit and the transformer form an inverter circuit to providing an AC voltage for driving the lamp. When the backlight control circuit works in a startup mode, the backlight control circuit defines a first current path including the lamp and the first current path forms a first resonant circuit. When the backlight control circuit works in an operation mode, the backlight control circuit defines a second current path including the lamp and the second current path forms a second resonant circuit. The first and second resonant circuits have different resonant frequencies from each other.

Other novel features and advantages will become more apparent from the following detailed description when taken in conjunction with the accompanying drawings.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a diagram of a first embodiment of a backlight control circuit.

FIG. 2 is a diagram of a second embodiment of a backlight control circuit.

FIG. 3 is a diagram of a third embodiment of a backlight control circuit.

FIG. 4 is a diagram of a typical backlight control circuit.

### DETAILED DESCRIPTION

Reference will now be made to the drawings to describe various embodiments in detail.

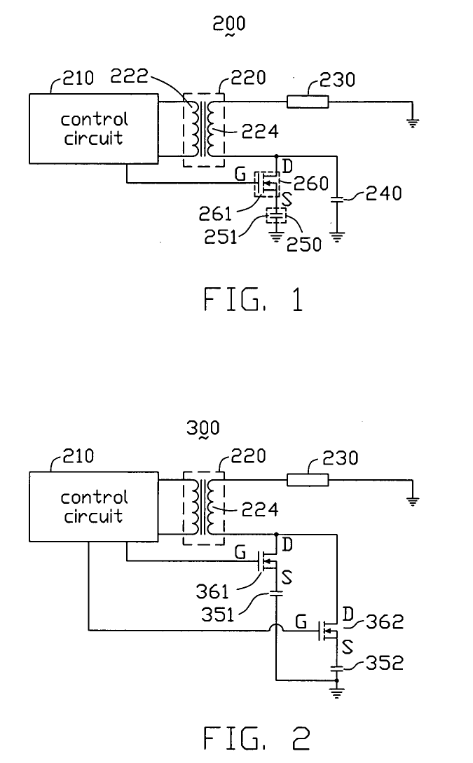

Referring to FIG. 1, a first embodiment of a backlight control circuit 200 includes a control circuit 210, a transformer 220, a lamp 230, a first capacitor 240, a reactance element 250, and a switching element 260.

The lamp 230 is typically a cold cathode fluorescent lamp. The control circuit 210 and the transformer 220 constitute an inverter circuit to providing an AC voltage for driving the lamp 230. The transformer 220 includes a primary winding 222 and a secondary winding 224. Two terminals of the primary winding 222 are electrically coupled to the control circuit 210. A first terminal of the secondary winding 224 is grounded via the lamp 230. A second terminal of the secondary winding 224 is grounded via the first capacitor 240.

The switching element 260 is a metal-oxide-semiconductor field-effect transistor (MOSFET) 261, which includes a gate electrode “G”, a source electrode “S”, and a drain electrode “D”. The reactance element 250 includes a second capacitor 251. The gate electrode “G” of the MOSFET 261 is connected to the control circuit 210. The drain electrode “D” of the MOSFET 261 is connected to the second terminal of the secondary winding 224. The source electrode “S” of the MOSFET 261 is grounded via the second capacitor 251.

When the backlight control circuit 200 works in a startup mode for initially lighting up the lamp 230, the inverter circuit formed by the control circuit 210 and the transformer 220 outputs a startup AC voltage with a first frequency f₁ to light up the lamp 230. The control circuit 210 outputs a low level voltage to the gate electrode “G” of the MOSFET 261 in order to switch off the MOSFET 261. Thus the lamp 230, the secondary winding 224, and the first capacitor 240 form a first resonant circuit which has a resonant frequency f₀₁ corresponding to or equal to the first frequency f₁.

When the backlight control circuit 200 works in an operation mode for driving the lamp 230 to radiate light according to desired normal operation, the inverter circuit formed by the control circuit 210 and the transformer 220 outputs an operation AC voltage with a second frequency f₂ to drive the lamp 230. The control circuit 210 outputs a high level voltage to the gate electrode “G” of the MOSFET 261 in order to switch on the MOSFET 261. Thus the lamp 230, the secondary winding 224, the first capacitor 240, the on-state MOSFET 261, and the second capacitor 251 form a second resonant circuit which has a second resonant frequency f₀₂ corresponding to or equal to the second frequency f₂.

Each of the first resonant frequency f₀₁ and the second resonant frequency f₀₂ can be calculated according to the following formula (1):

$$f = \frac{1}{2 π \sqrt{LC}} . \qquad ( 1 )$$

In formula (1), “f” denotes a resonant frequency of a resonant circuit. “L” denotes a sum of inductances of the resonant circuit. “C” denotes a sum of capacitances of the resonant circuit. Because the second resonant circuit further includes the second capacitor 251 connected in parallel with the first capacitor 240, the sum of capacitances of the second resonant circuit is larger than that of the first resonant circuit. Thus the second resonant frequency f₀₂ is less than the first resonant frequency f₀₁. The second resonant frequency f₀₂ can be set to be the second frequency f₂ of the operation AC voltage by setting an appropriate capacitance of the second capacitor 251.

Because the backlight control circuit 200 respectively defines the first resonant circuit in the startup mode and the second resonant circuit in the operation mode, the first resonant frequency f₀₁ of the first resonant circuit corresponds to the first frequency f₁ of the startup AC voltage, and the second resonant frequency f₀₂ of the second resonant circuit corresponds to the second frequency f₂ of the operation AC voltage. Accordingly, any flicker of the lamp 230 that might otherwise occur is eliminated or depressed, and the efficiency of the backlight control circuit 200 is high.

Referring to FIG. 2, a backlight control circuit 300 of a second embodiment is shown. The backlight control circuit 300 may be substantially similar to the backlight control circuit 200, except that the backlight control circuit 300 includes a first MOSFET 361, a second MOSFET 362, a first capacitor 351, and a reactance element such as a second capacitor 352. Gate electrodes “G” of the first and second MOSFETs 361, 362 are connected to the control circuit 210. The second terminal of the secondary winding 224 is connected to drain electrodes “D” of the first and second MOSFETs 361, 362. A source electrode “S” of the first MOSFET 361 is connected to ground via the first capacitor 351. A source electrode “S” of the second MOSFET 362 is connected to ground via the second capacitor 352. A capacitance of the first capacitor 351 is less than that of the second capacitor 352.

When the backlight control circuit 300 works in a startup mode for initially lighting up the lamp 230, the inverter circuit formed by the control circuit 210 and the transformer 220 outputs a startup AC voltage with the first frequency f₁ to light up the lamp 230. The control circuit 210 switches on the first MOSFET 361 and switches off the second MOSFET 362. Thus the lamp 230, the secondary winding 224, the on-state first MOSFET 361, and the first capacitor 351 form a first resonant circuit, which has a resonant frequency f₀₁ corresponding to or equal to the first frequency f₁.

When the backlight control circuit 300 works in an operation mode for driving the lamp 230 to radiate light according to desired normal operation, the inverter circuit formed by the control circuit 210 and the transformer 220 outputs an operation AC voltage with the second frequency f₂ to drive the lamp 230. The control circuit 210 switches off the first MOSFET 361 and switches on the second MOSFET 362. Thus the lamp 230, the secondary winding 224, the on-state second MOSFET 362, and the second capacitor 352 form a second resonant circuit, which has a second resonant frequency f₀₂ corresponding to or equal to the second frequency f₂.

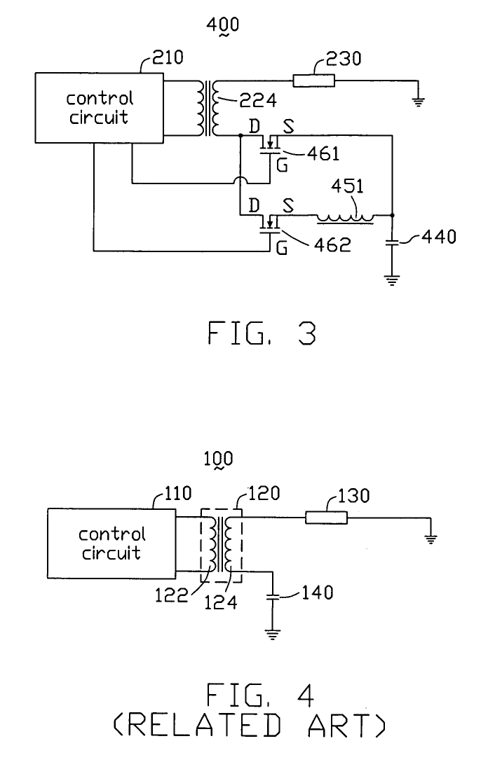

Referring to FIG. 3, a backlight control circuit 400 of a third embodiment is shown. The backlight control circuit 400 may be substantially similar to the backlight control circuit 200 of FIG. 1, except that the backlight control circuit 400 includes a first MOSFET 461, a second MOSFET 462, a capacitor 440, and a reactance element such as an inductor 451. Gate electrodes “G” of the first and second MOSFETs 461, 462 are connected to the control circuit 210. The second terminal of the secondary winding 224 is connected to drain electrodes “D” of the first and second MOSFETs 461, 462. A source electrode “S” of the first MOSFET 461 is connected to ground via the capacitor 440. A source electrode “S” of the second MOSFET 462 is connected to ground via the inductor 451 and the capacitor 440 in series.

When the backlight control circuit 400 works in a startup mode for initially lighting up the lamp 230, the inverter circuit formed by the control circuit 210 and the transformer 220 outputs a startup AC voltage with the first frequency f₁ to light up the lamp 230. The control circuit 210 switches on the first MOSFET 461 and switches off the second MOSFET 462. Thus the lamp 230, the secondary winding 224, the on-state first MOSFET 461, and the first capacitor 440 form a first resonant circuit, which has a resonant frequency f₀₁ corresponding to or equal to the first frequency f₁.

When the backlight control circuit 400 works in an operation mode for driving the lamp 230 to radiate light according to desired normal operation, the inverter circuit formed by the control circuit 210 and the transformer 220 outputs an operation AC voltage with the second frequency f₂ to drive the lamp 230. The control circuit 210 switches off the first MOSFET 461 and switches on the second MOSFET 462. Thus the lamp 230, the secondary winding 224, the on-state second MOSFET 462, the inductor 451, and the capacitor 440 form a second resonant circuit, which has a second resonant frequency f₀₂ corresponding to or equal to the second frequency f₂.

In an alternative embodiment, the inductor 451 can be replaced by a capacitor. In other alternative embodiments, the capacitors 251, 351 can be replaced by inductors.

It is to be further understood that even though numerous characteristics and advantages of the present disclosure have been set out in the foregoing description, together with details of the structures and functions of the embodiments, the disclosure is illustrative only; and that changes may be made in detail, especially in matters of arrangement of parts within the principles of the invention to the full extent indicated by the broad general meaning of the terms in which the appended claims are expressed.

What is claimed is:

1. A backlight control circuit comprising:
a transformer, a control circuit, and a lamp, the control circuit and the transformer forming an inverter circuit capable of providing an alternating current (AC) voltage for driving the lamp,
wherein when the backlight control circuit works in a startup mode, the backlight control circuit defines a first current path comprising the lamp and the first current path forms a first resonant circuit; and
when the backlight control circuit works in an operation mode, the backlight control circuit defines a second current path comprising the lamp and the second current path forms a second resonant circuit, the first and second resonant circuits having different resonant frequencies from each other.

2. The backlight control circuit of claim 1, wherein the transformer comprises a primary winding and a secondary winding, two terminals of the primary winding are coupled to the control circuit, and the AC voltage is outputted from the secondary winding.

3. The backlight control circuit of claim 2, further comprising a first capacitor, a reactance element, and a switching element, the first resonant circuit being formed by the lamp, the secondary winding and the first capacitor, the second resonant circuit being formed by the lamp, the secondary winding, the switching element, the reactance element and the first capacitor.

4. The backlight control circuit of claim 3, wherein one terminal of the secondary winding is connected to ground via the lamp, and the other terminal of the secondary winding is connected to ground via the first capacitor.

5. The backlight control circuit of claim 4, wherein the switching element is configured to selectively open or close and thereby form the first resonant circuit or the second resonant circuit.

6. The backlight control circuit of claim 4, wherein the other terminal of the secondary winding is also connected to ground via two conducting electrodes of the switching element and the reactance element in series, and a control electrode of the switching element is connected to the control circuit.

7. The backlight control circuit of claim 6, wherein the switching element is a metal-oxide-semiconductor field-effect transistor (MOSFET).

8. The backlight control circuit of claim 6, wherein the reactance element comprises a second capacitor.

9. The backlight control circuit of claim 6, wherein the reactance element is an inductor.

10. The backlight control circuit of claim 2, further comprising a first capacitor, a reactance element, a first switching element, and a second switching element, the first resonant circuit being formed by the lamp, the secondary winding, the first switching element, and the first capacitor, the second resonant circuit being formed by the lamp, the secondary winding, the second switching element, and the reactance element.

11. The backlight control circuit of claim 10, wherein the first switching element is configured to selectively open or close the first resonant circuit, and the second switching element is configured to selectively open or close the second resonant circuit.

12. The backlight control circuit of claim 11, wherein one terminal of the secondary winding is connected to ground via the lamp, and the other terminal of the secondary winding is connected to ground via two conducting electrodes of the first switching element and the first capacitor in series, and is also connected to ground via two conducting electrodes of the second switching element and the reactance element in series, and control electrodes of the first and second switching elements are connected to the control circuit.

13. The backlight control circuit of claim 12, wherein the reactance element is a second capacitor.

14. The backlight control circuit of claim 12, wherein the reactance element is an inductor.

15. The backlight control circuit of claim 12, wherein the first and second switching elements are metal-oxide-semiconductor field-effect transistors (MOSFETs).

16. The backlight control circuit of claim 10, wherein one terminal of the secondary winding is connected to ground via the lamp, and the other terminal of the secondary winding is connected to ground via two conducting electrodes of the first switching element and the first capacitor in series, and is also connected to ground via two conducting electrodes of the second switching element, the reactance element, and the first capacitor in series, and control electrodes of the first and second switching elements are connected to the control circuit.

17. The backlight control circuit of claim 16, wherein the reactance element is an inductor.

18. The backlight control circuit of claim 16, wherein the reactance element is a second capacitor.

19. A backlight control method for driving a lamp, the method comprising:
defining a first resonant circuit comprising the lamp in a startup mode for initially lighting up the lamp, and
defining a second resonant circuit comprising the lamp in an operation mode for driving the lamp to radiate light according to desired normal operation,
wherein the first and the second resonant circuits have resonant frequencies different from each other.
